(19) United States
(12) Patent Application Publication
(10) Pub. No.: US 2020/0290904 A1
(43) Pub. Date: Sep. 17, 2020

(54) Blackwater Treatment

(71) Applicant: Hall Labs LLC, Provo, UT (US)

(72) Inventors: David R. Hall, Provo, UT (US); Michael Hall, Provo, UT (US); Thomas Corie, Springville, UT (US); Cody Rees, Provo, UT (US)

(73) Assignee: Hall Labs LLC, Provo, UT (US)

(21) Appl. No.: 16/299,459

(22) Filed: Mar. 12, 2019

(51) Int. Cl. C02F 1/68; C02F 1/20

(52) U.S. Cl. CPC C02F 1/68; C02F 2103/005; C02F 1/20

(57) ABSTRACT

Methods, devices, and systems for treating blackwater are disclosed. A storage tank and a tumbling kiln charged with a solid media are provided. Blackwater is passed into the storage tank. The blackwater contains a liquid component and a solid component. The solid media and the tumbling kiln are heated. The blackwater is passed from the storage tank to the tumbling kiln. A portion of the liquid component is vaporized as vapor. A portion of the solid component is combusted to produce combustion gases. Fresh air is circulated into the tumbling kiln. The vapor and the combustion gases are removed from the tumbling kiln.

### TECHNICAL FIELD

This invention relates generally to treatment of blackwater.

### BACKGROUND

Blackwater is typically treated at a central facility in large quantities in most population centers. Treatment of small amounts of blackwater in remote locations, and thus in small quantities, is difficult and not often addressed.

One application where treatment of small amounts of blackwater would be especially beneficial would be for mobile applications, such as recreational vehicles (RV's). Currently, the typically RV merely has a tank for storing blackwater generated on the RV. Depending on its capacity and the amount of blackwater generated, this tank must be periodically emptied and flushed, sometimes as frequently as every few days. If, instead, there was a workable system for treating the Blackwater generated on an RV, that would avoid this unpleasant, inefficient or sometimes expensive process. Such a system on an RV would also allow the RV to travel more freely, unconstrained by the need to find dumping stations.

### SUMMARY

In a first aspect, the disclosure provides a system for treating blackwater. The system includes a storage tank, a tumbling kiln, a heat source, and a blackwater intake. The storage tank is configured to receive blackwater. The blackwater consists of a liquid component and a solid component. The tumbling kiln is charged with a solid media. The tumbling kiln includes an air circulation system consisting of an air intake and an exhaust. The heat source is configured to heat the tumbling kiln and the solid media. The blackwater intake is adapted to allow the blackwater into the tumbling kiln. The solid media and the heat source are configured to vaporize at least a portion of the liquid component to produce vapor and to combust at least a portion of the solid component to produce combustion gases. The air intake is configured to draw fresh air into the tumbling kiln. The exhaust is configured to draw the combustion gases and the vapor out of the tumbling kiln.

In a second aspect, the disclosure provides a method for treating blackwater. A storage tank and a tumbling kiln charged with a solid media are provided. Blackwater is passed into the storage tank. The blackwater contains a liquid component and a solid component. The solid media and the tumbling kiln are heated. The blackwater is passed from the storage tank to the tumbling kiln. A portion of the liquid component is vaporized as vapor. A portion of the solid component is combusted to produce combustion gases. Fresh air is circulated into the tumbling kiln. The vapor and the combustion gases are removed from the tumbling kiln.

In a third aspect, the disclosure provides a device for treating blackwater. The device includes a storage tank, a tumbling kiln, a heat source, and a blackwater intake. The blackwater is passed into the storage tank. The blackwater includes a liquid component and a solid component. The tumbling kiln is charged with a solid media. The tumbling kiln includes an air circulation system with an air intake and an exhaust. The heat source heats the tumbling kiln and the solid media. The blackwater intake allows the blackwater into the tumbling kiln. At least a portion of the liquid component is vaporized to produce vapors and at least a portion of the solid component is combusted to produce combustion gases. The combustion gases and vaporized liquid pass out of the tumbling kiln through the exhaust. Fresh air is drawn into the tumbling kiln through the air intake.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A is a top view of a system for treating blackwater as per one embodiment of the present invention.

FIG. 1B is a top-left perspective isometric view of the system of FIG. 1A.

FIG. 1C is a top-right perspective isometric view of the system of FIG. 1A.

FIG. 1D is a cutaway top perspective isometric view of the tumbling kiln of FIG. 1A.

FIG. 2 is a top perspective isometric view of a device for treating blackwater as per one embodiment of the present invention.

FIG. 3 is a block diagram showing a method for treating blackwater that may be used as per one embodiment of the present invention.

FIG. 4 is a block diagram showing a method for treating blackwater that may be used as per one embodiment of the present invention.

FIG. 5 is a perspective view of the preferred application of the blackwater treatment system on a recreational vehicle.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “charge” is meant to refer to the amount of material provided to the tumbling kiln. When a kiln is “charged,” the kiln is loaded with an appropriate amount of solid media.

As used herein, “blackwater” is meant to refer to waste consisting of solids and liquids, organic and/or inorganic. This may include water, urine, feces, paper products, or combinations thereof.

Blackwater treatment for small quantities and in remote locations is desirable. These include recreational vehicles, campsites, isolated villages, and industrial sites, among many others. Typically, small quantities are simply stored until storage capacity is full. At that point, the blackwater is either carried out and delivered to treatment centers (as in recreational vehicles) or is pumped into trucks and delivered to treatment centers (as in outhouses). Rather than carry out the waste, the present application discloses methods, devices, and systems for treatment of blackwater. Blackwater consists of a liquid component (mostly water) and a solid component (mostly fecal matter). A tumbling kiln is charged with a solid media. In a preferred embodiment, this solid media is volcanic rock. The tumbling kiln and solid media are heated. In some embodiments, the heating is accomplished by combustion of propane. Alternatively, other combustible gases, such as natural gas, or other heat sources can be used. Blackwater is placed in a storage tank. In some embodiments, the blackwater is macerated for homogenization. The blackwater is passed into the tumbling kiln where the liquid component is vaporized and the solid component is combusted. An air circulation system draws in fresh air for the combustion and draws the combustion gases and vapors out of the tumbling kiln.

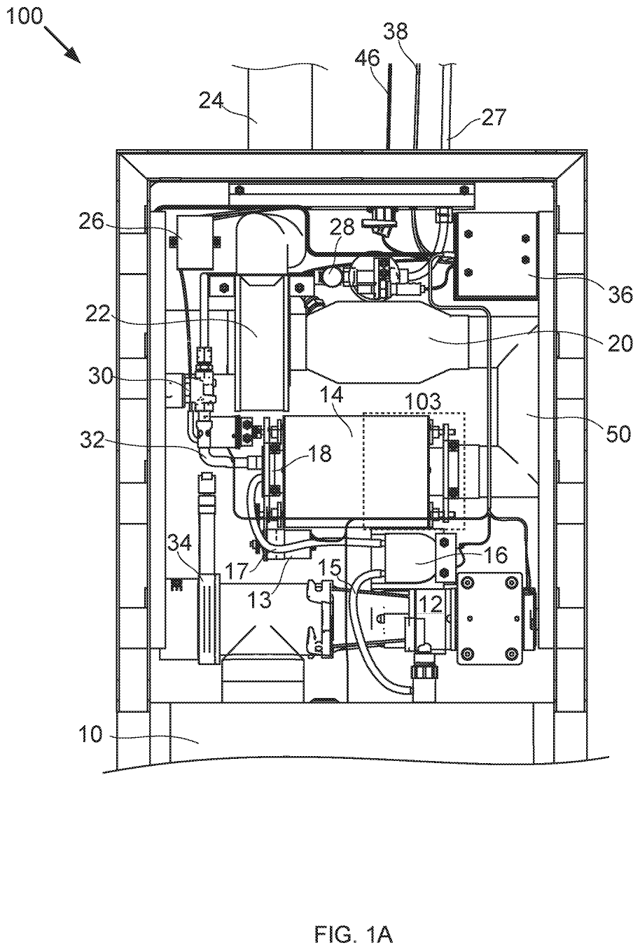

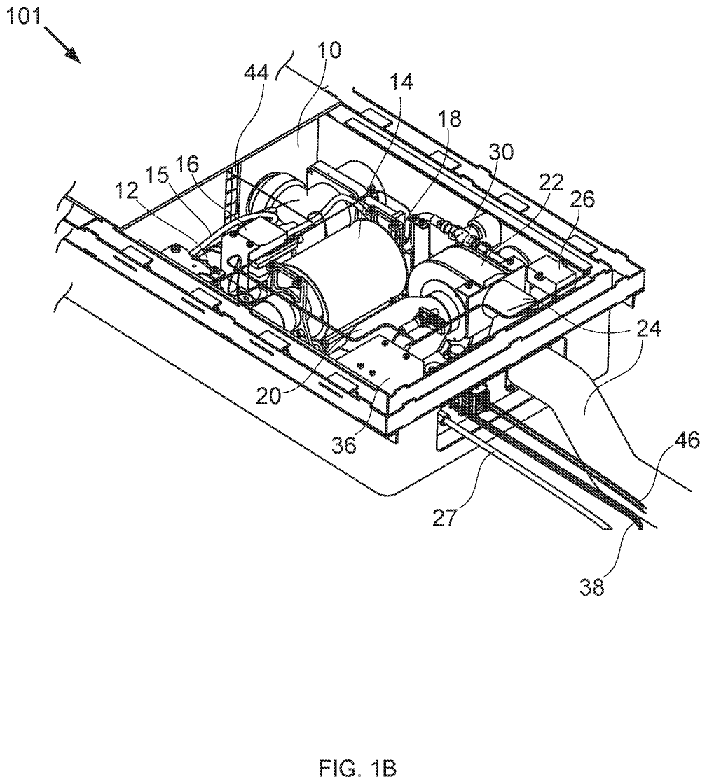

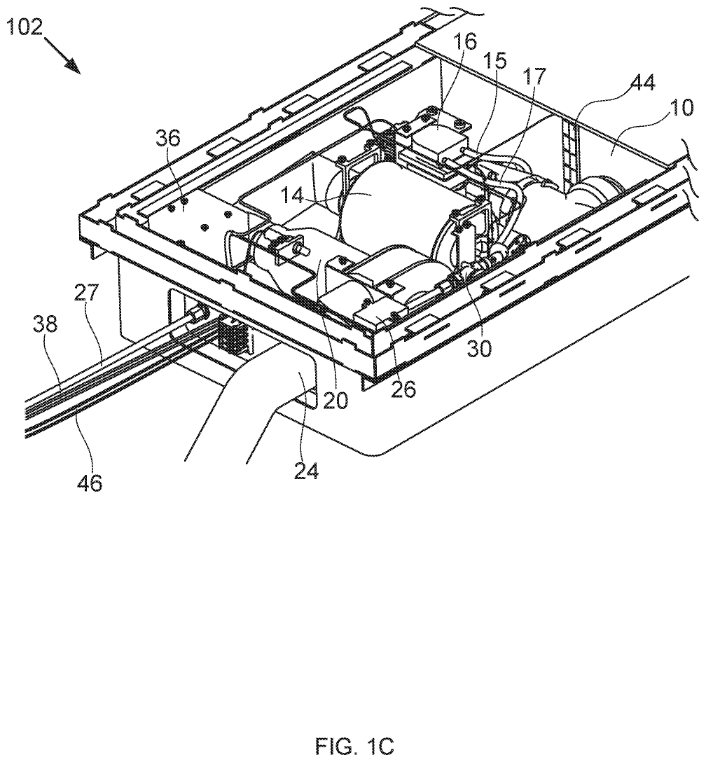

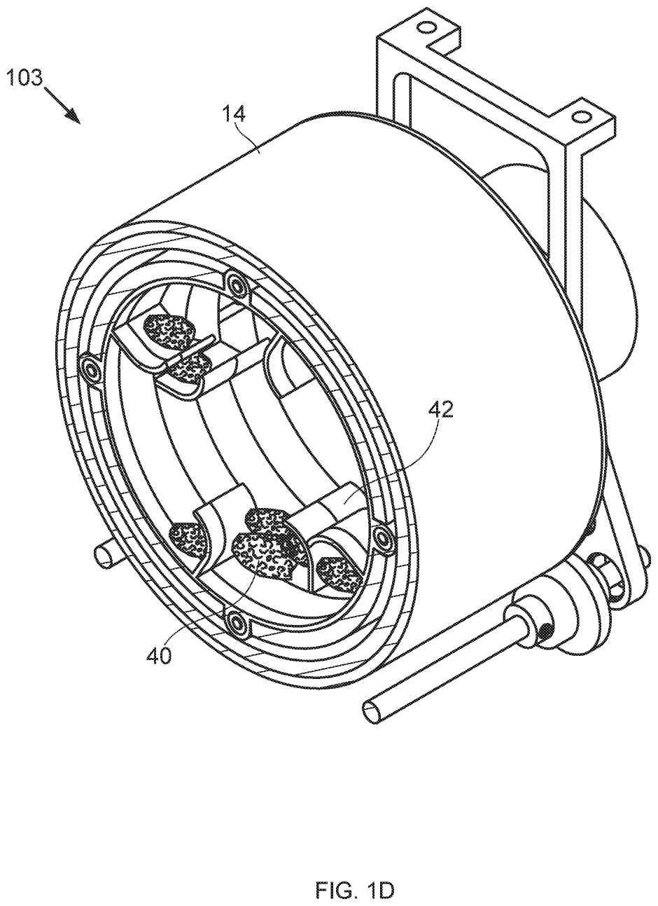

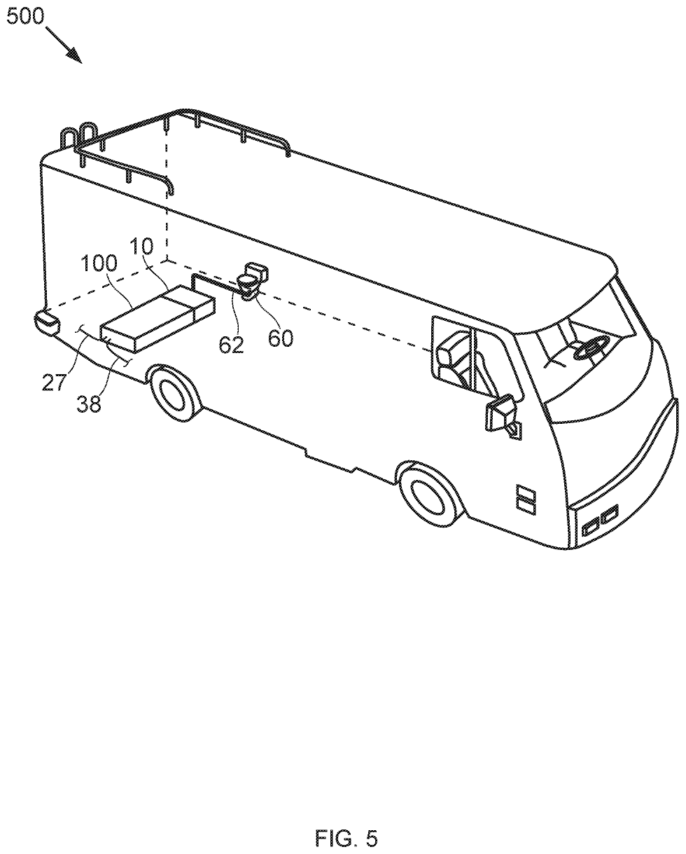

Now referring to FIG. 5, FIG. 5 is an isometric elevation view of a recreational vehicle 500 that may use the methods, systems, and devices disclosed herein. In a preferred embodiment, the recreational vehicle 500 has had its original blackwater tank replaced by the system shown in FIG. 1A. This retrofitting of the existing blackwater tank maintains all the important features of blackwater storage for recreational vehicles, with the added benefit of the ability to treat the blackwater, removing a need for dumping of the blackwater. The recreational vehicle 500 has had its old blackwater tank replaced with the system 100 for treating the blackwater, including a smaller blackwater tank 10. The system 100 includes a slide valve for conventional disposal of waste in emergencies. The system 100 is integrated into the recreational vehicle 500 by electrical connections 38 and propane connection 27 and by toilet 60 with blackwater line 62.

Now referring to FIGS. 1A-D, FIG. 1A is a top view of a system 100 for treating blackwater as per one embodiment of the present invention. FIG. 1B is a top-left perspective isometric view of the system 101 of FIG. 1A. FIG. 1C is a top-right perspective isometric view of the system 102 of FIG. 1A. FIG. 1D is a cutaway top perspective isometric view of the tumbling kiln 103 of FIG. 1A. The tumbling kiln 14 contains a solid media 40. As the tumbling kiln 14 is rotated by drive 13, lifting vanes 42 tumble the solid media 40. Propane is passed into the system by line 27, through a propane regulator 28 and a propane solenoid valve 30 and into the tumbling kiln 14 via line 32. A spark ignition control system 26, fed power by an electrical control box 36, ignites the propane as it enters the tumbling kiln 14. In a preferred embodiment, the electrical control box 36 is connected by wires 38 to the power of a recreational vehicle, such as in FIG. 5. The tumbling kiln 14 and the solid media 40 are preheated by the combustion of the propane.

A storage tank 10 receives the blackwater from a blackwater source, such as a toilet. The blackwater consists of a liquid component and a solid component. A macerator pump 12 receives the blackwater, homogenizing the blackwater and recycling the blackwater to the storage tank 10. Homogenization involves grinding of larger solids down to a finer size. A peristaltic pump 16 pumps the homogenized blackwater by a hose 15 into a hose 17 and into a tumbling kiln 14. Fresh air is drawn into the tumbling kiln 14 through an inlet 18 by a blower 22. The liquid component in the tumbling kiln 14 is vaporized to form a vapor. A portion of the solid component in the tumbling kiln 14 is combusted to form combustion gases. The pre-heating of the tumbling kiln 14 and the solid media 40 provides a portion of the heat required for the vaporization and the combustion. The propane combustion continues to supply any remaining heat required to finish the vaporization and the combustion. The vapor and the combustion gases are drawn by the blower 22 out of the tumbling kiln 14 through a catalytic converter 20, through the blower 22, and out the exhaust 24. Preferably, the catalytic converter used conventional technology to convert toxic gases and pollutants into less-toxic pollutants by catalyzing a redox reaction (an oxidation and a reduction reaction).

In a preferred embodiment, a level sensor 44 is provided that detects the level of blackwater in the blackwater storage tank 10. The sensor is connected to a controller via wires 46. In a preferred embodiment, the level sensor 44 detects that the level in the storage tank 10 is above a threshold and starts the system to treat the blackwater.

In some embodiments, the combustion of the solid component is incomplete, leaving a portion of the solid component as an ash. This ash is added to the solid media 40 until it is built up. The solid media 40 is then removed from the tumbling kiln and cleared of ash. In some embodiments, this is done through a trap in a duct 50 between the tumbling kiln 14 and the catalytic converter 20.

In some embodiments, the macerator 12 grinds the blackwater to a fine enough grind that the blackwater can be sprayed. In this embodiment, the blackwater is sprayed into the tumbling kiln 14.

The blackwater may be discharged from the system in an emergency or otherwise as desired via a slide valve 34.

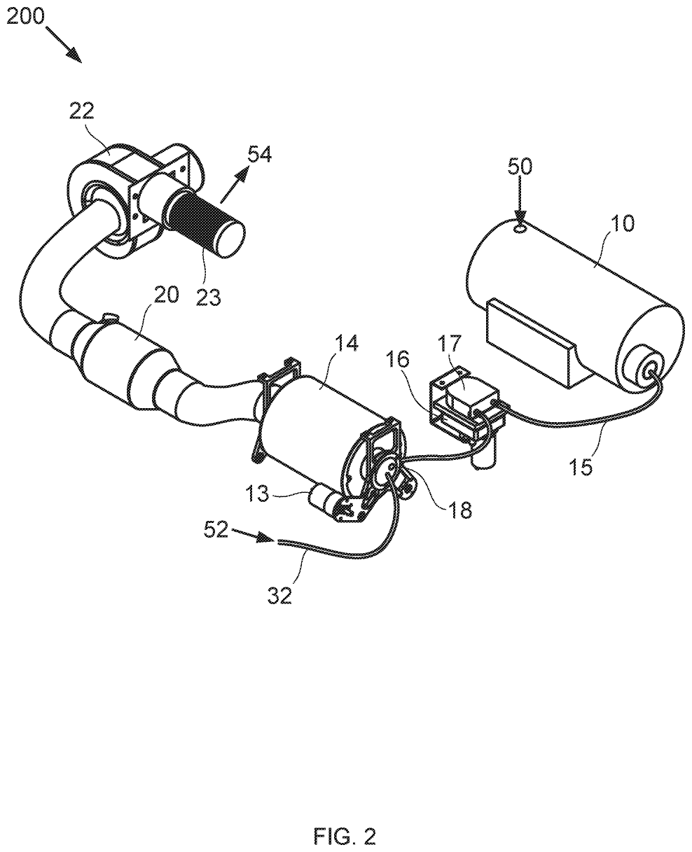

Now referring to FIG. 2, FIG. 2 is a top perspective isometric view 200 of a device for treating blackwater as per one embodiment of the present invention. The tumbling kiln 14 contains a solid media. As the tumbling kiln 14 is rotated by drive 13, lifting vanes tumble the solid media. Propane 52 is passed into the tumbling kiln 14 by line 32 where it is combusted. The tumbling kiln 14 and the solid media 40 are preheated by the combustion of the propane. A storage tank 10 has blackwater 50 passed into it. The blackwater 50 is pumped by peristaltic pump 16 through inlet hose 15 and out outlet hose 17 into the tumbling kiln 14. Fresh air is drawn into the tumbling kiln 14 through an inlet 18 by a blower 22. The liquid component in the tumbling kiln 14 is vaporized to form a vapor. A portion of the solid component in the tumbling kiln 14 is combusted to form combustion gases. The pre-heating of the tumbling kiln 14 and the solid media provides a portion of the heat required for the vaporization and the combustion. The propane combustion continues to supply any remaining heat required to finish the vaporization and the combustion. The vapor and the combustion gases are drawn by the blower 22 out of the tumbling kiln 14 through a catalytic converter 20, through the blower 22, and out an exhaust filter 23 as exhaust gases 54.

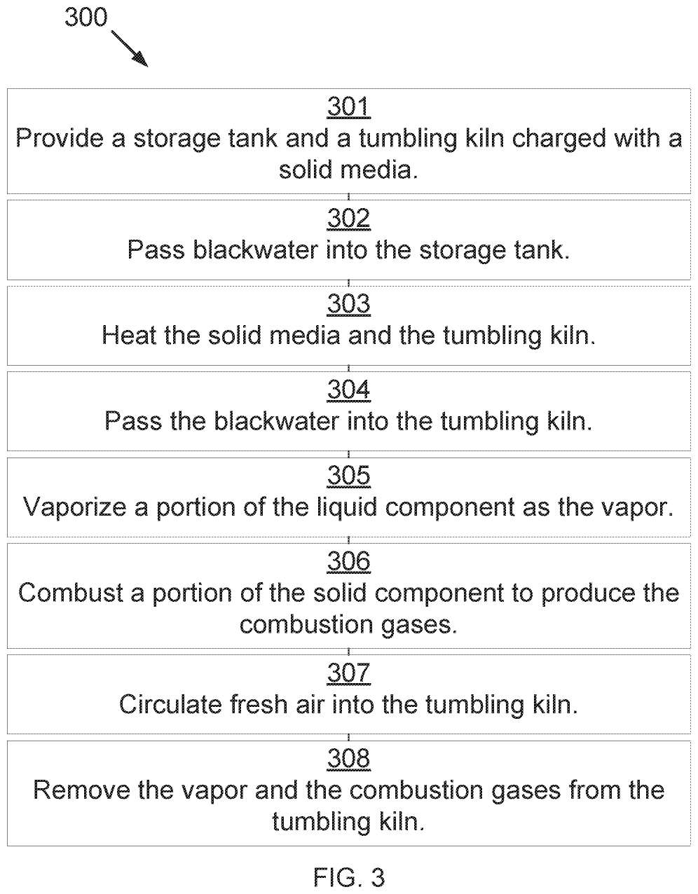

Now referring to FIG. 3, FIG. 3 is a block diagram 300 showing a method for treating blackwater that may be used as per one embodiment of the present invention. At 301, a storage tank and tumbling kiln charged with a solid media are provided. At 302, blackwater, consisting of a liquid component and a solid component, is passed into the storage tank. At 303, the solid media and the tumbling kiln are heated. At 304, the blackwater is passed from the storage tank to the tumbling kiln. At 305, a portion of the liquid component is vaporized as a vapor. At 306, a portion of the solid component is combusted to produce combustion gases. At 307, fresh air is circulated into the tumbling kiln. At 308, the vapor and the combustion gases are removed from the tumbling kiln.

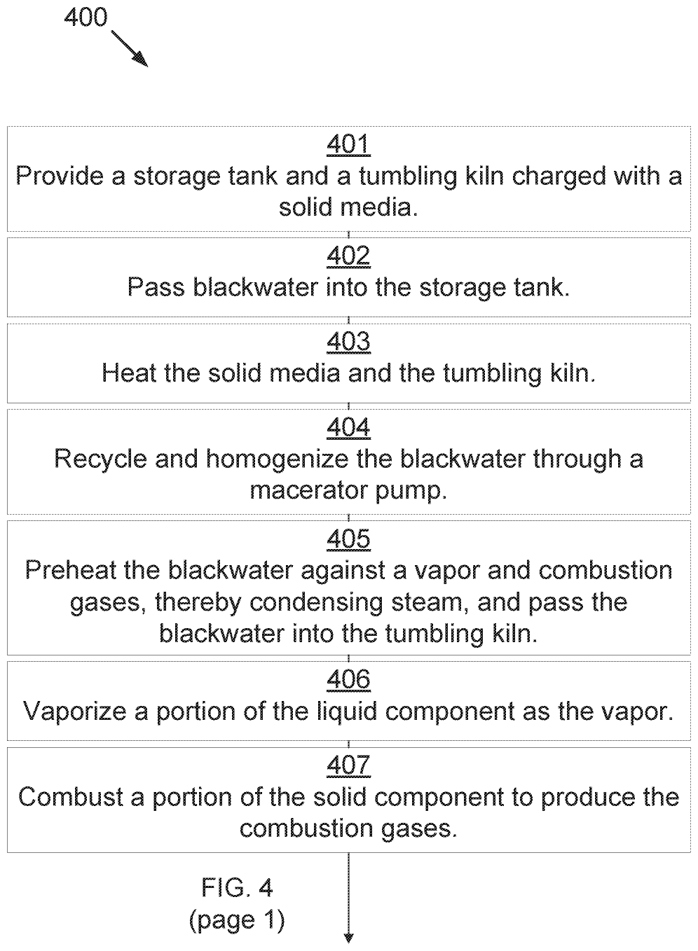

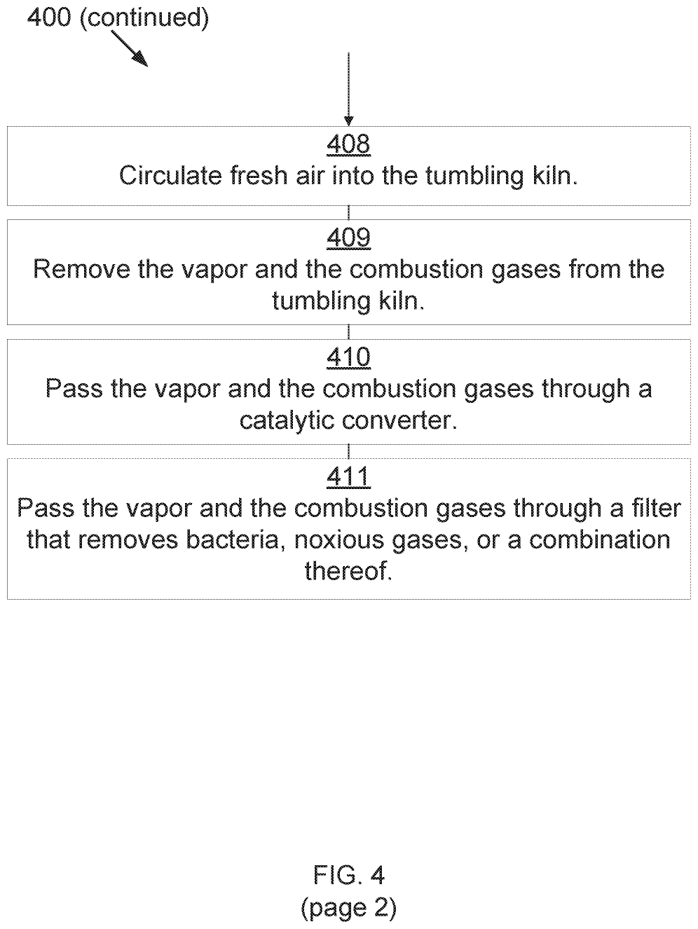

Now referring to FIG. 4, FIG. 4 is a block diagram 400 showing a method for treating blackwater that may be used as per one embodiment of the present invention. At 401, a storage tank and tumbling kiln charged with a solid media are provided. At 402, blackwater, consisting of a liquid component and a solid component, is passed into the storage tank. At 403, the solid media and the tumbling kiln are heated. At 404, the blackwater is recycled and homogenized through a macerator pump. At 405, the blackwater is preheated against a vapor and combustion gases in a condensing indirect-contact heat exchanger as it is passed from the storage tank to the tumbling kiln, resulting in the blackwater becoming preheated and a portion of any steam being condensed out of the vapor and the combustion gases. At 406, a portion of the liquid component is vaporized as the vapor. At 407, a portion of the solid component is combusted to produce the combustion gases. At 408, fresh air is circulated into the tumbling kiln. At 409, the vapor and the combustion gases are removed from the tumbling kiln and passed to the condensing indirect-contact heat exchanger. At 410, the vapor and the combustion gases are passed through a catalytic converter. At 411, the vapor and the combustion gases are passed through a filter that removes bacteria, noxious gases, or a combination thereof.

In some embodiments, the heat source is selected from the group consisting of a burner fed by a combustible compound, an electrical resistance heater, recycled combustion gases, recycled waste heat, and combinations thereof.

In some embodiments, the blackwater is preheated by a heat exchanger.

In some embodiments, the solid media is volcanic rock, porous ceramics, 3D-printed metals, or combinations thereof.

In some embodiments, fuel is added to the blackwater during the homogenizing grind by the macerator pump. The fuel is selected from the group consisting of oil, diesel fuel, gasoline, wood pellets, coal dust, and combinations thereof. Adding fuel at this stage leads to faster and more complete combustion of the blackwater in the tumbling kiln.

The invention has been described with reference to various specific and preferred embodiments and techniques. Nevertheless, it is understood that many variations and modifications may be made while remaining within the spirit and scope of the invention.

What is claimed is:

1. A system for treating blackwater comprising:
a storage tank configured to receive the blackwater, the blackwater comprising a liquid component and a solid component,
a tumbling kiln charged with a solid media, the tumbling kiln comprising an air circulation system comprising an air intake and an exhaust,
a heat source configured to heat the tumbling kiln and the solid media,
a blackwater intake adapted to allow the blackwater into the tumbling kiln,
the solid media and the heat source configured to vaporize at least a portion of the liquid component to produce a vapor and to combust at least a portion of the solid component to produce combustion gases,
the air intake configured to draw fresh air into the tumbling kiln, and
the exhaust configured to draw the combustion gases and the vapor out of the tumbling kiln.

2. The invention of claim 1, wherein the heat source is selected from the group consisting of a burner fed by a combustible compound, an electrical resistance heater, recycled combustion gases, recycled waste heat, and combinations thereof.

3. The invention of claim 1, further comprising a condenser.

4. The invention of claim 1, further comprising a heat exchanger after the blackwater intake and before the tumbling kiln that preheats the blackwater.

5. The invention of claim 1, wherein the exhaust further comprises a catalytic converter.

6. The invention of claim 1, further comprising a filter to remove bacteria, noxious gases, or combinations thereof.

7. The invention of claim 1, further comprising a macerator pump that circulates and homogenizes the blackwater.

8. The invention of claim 1, wherein the blackwater intake comprises a pump.

9. The invention of claim 1, wherein the blackwater intake comprises a sprayer.

10. A method for treating blackwater comprising:
providing a storage tank and a tumbling kiln charged with a solid media,
passing the blackwater into the storage tank, the blackwater comprising a liquid component and a solid component,
heating the solid media and the tumbling kiln,
passing the blackwater from the storage tank to the tumbling kiln,
vaporizing a portion of the liquid component as a vapor,
combusting a portion of the solid component to produce combustion gases,
circulating fresh air into the tumbling kiln, and
removing the vapor and the combustion gases from the tumbling kiln.

11. The invention of claim 10, wherein the heating the solid media and the tumbling kiln step is accomplished by a heat source, the heat source selected from the group consisting of a burner fed by a combustible compound, an electrical resistance heater, recycled combustion gases, recycled waste heat, and combinations thereof.

12. The invention of claim 10, further comprising capturing steam out of the vapor and the combustion gases.

13. The invention of claim 10, further comprising preheating the blackwater between the storage tank and the tumbling kiln.

14. The invention of claim 10, further comprising passing the vapor and the combustion gases through a first side of a condensing heat exchanger and the blackwater through a second side of the condensing heat exchanger, thus preheating the blackwater and condensing steam out of the vapor and the combustion gases.

15. The invention of claim 10, further comprising passing the vapor and the combustion gases through a catalytic converter.

16. The invention of claim 10, further comprising homogenizing the blackwater by a macerator pump attached in a loop connected to the storage tank.

17. The invention of claim 16, further comprising adding fuel to the blackwater during homogenizing, the fuel selected from the group consisting of oil, diesel fuel, gasoline, wood, coal dust, and combinations thereof.

18. The invention of claim 16, wherein homogenizing produces a grind fine enough that the blackwater is sprayable and wherein passing the blackwater from the storage tank to the tumbling kiln comprises spraying the blackwater into the combustion kiln.

19. A device for treating blackwater comprising:
a storage tank, wherein the blackwater is passed into the storage tank, the blackwater comprising a liquid component and a solid component,
a tumbling kiln charged with a solid media, the tumbling kiln comprising an air circulation system comprising an air intake and an exhaust,
a heat source that heats the tumbling kiln and the solid media,
a blackwater intake that allows the blackwater into the tumbling kiln,
wherein at least a portion of the liquid component is vaporized to produce a vapor and at least a portion of the solid component is combusted to produce combustion gases, and wherein the combustion gases and the vapor pass out of the tumbling kiln through the exhaust while fresh air is drawn into the tumbling kiln through the air intake.

20. The invention of claim 19, wherein the solid media is selected from the group consisting of volcanic rock, porous ceramics, 3D-printed metals, and combinations thereof.
